(19) United States
(12) Patent Application Publication
(10) Pub. No.: US 2006/0130709 A1
(43) Pub. Date: Jun. 22, 2006

(54) Liquid galvanic coatings for protection of embedded metals

(76) Inventors: Boris A. Miksic, North Oaks, MN (US); Marlin Hansen, White Bear Lake, MN (US); Joseph Curran, Melbourne Beach, FL (US); Louis G. MacDowell, Satellite Beach, FL (US)

Correspondence Address: HAUGEN LAW FIRM, SUITE 1130 - TCF TOWER, 121 SOUTH EIGHTH STREET, MINNEAPOLIS, MN, 55402, US

(21) Appl. No.: 11/354,327

(22) Filed: Feb. 14, 2006

Related U.S. Application Data
(62) Division of application No. 10/673,711, filed on Sep. 29, 2003.
Application No. 10/673,711 is a continuation-in-part of application No. 09/977,531, filed on Oct. 15, 2001, now Pat. No. 6,627,065.
(60) Provisional application No. 60/253,069, filed on Nov. 20, 2000.

(51) Int. Cl. C04B 28/04

(52) U.S. Cl. 106/713

(57) ABSTRACT

A fluid galvanic coating for protecting corrosion-susceptible materials embedded within a substrate includes one or more metals selected from the group consisting of magnesium, zinc, and aluminum, one or more humectants, and one or more additives selected from the group consisting of conductive polymers, carbon fibers, and graphite.

### CROSS-REFERENCE TO RELATED APPLICATIONS

This application is a divisional application our of co-pending U.S. patent application Ser. No. 10/673,711, entitled “LIQUID GALVANIC COATINGS FOR PROTECTION OF EMBEDDED METALS” filed Sep. 29, 2003, which itself is a continuation-in-part of U.S. patent application Ser. No. 09/977,531, now U.S. Pat. No. 6,627,065, entitled “LIQUID GALVANIC COATINGS FOR PROTECTION OF IMBEDDED METALS”, and filed Oct. 15, 2001, which claims priority from U.S. provisional patent application Ser. No. 60/253,069, filed Nov. 20, 2000, entitled “LIQUID APPLIED COATINGS FOR PROTECTION OF METAL”, the contents of such applications are incorporated herein in their entirety.

### FIELD OF THE INVENTION

The present invention relates to corrosion reduction generally, and more particularly to the use of liquid galvanic coatings for the protection of metal structures embedded within a substrate, such as rebar embedded within concrete.

### BACKGROUND OF THE INVENTION

Corrosion of embedded metal structures is an on-going issue affecting a wide variety of applications. A particularly important situation in which such corrosion occurs is in the corrosion of reinforcing steel embedded within concrete, such as in building structures, roads, and bridges. Since the corrosion of e.g. reinforcing steel takes place within the corresponding concrete shell, the steel surface is not readily available to be directly protected through corrosion inhibiting surface coatings. Providing protection to the steel to significantly slow or stop the corrosion process would prevent further structural deterioration of the reinforced concrete system.

Other techniques have been used recently to offer protection of the steel reinforcing bars inside concrete structures. These include migrating corrosion inhibitors and cathodic protection systems. The chemical inhibitors promise quick and inexpensive protection, though the corrosion process can still continue in areas not sufficiently treated. Such chemical inhibitors only slow the corrosion process and can still lead to structural damage of the concrete. Cathodic corrosion protection methods work to arrest the corrosion process by providing electrical current or sacrificial anodes.

Some corrosion inhibiting methods in use today for protecting embedded corrosion-susceptible materials requires coating of the overall structure with a conductive paint and applying current by the use of an externally connected power supply. Such systems are costly to install, require continuous power supply and must be periodically monitored and maintained throughout the life of the structure. Sacrificial cathodic protection methods typically require the application of metallic zinc by arc or thermal spray equipment. Such equipment is bulky, expensive, and requires significant skill to operate.

Therefore, it is a primary object of the present invention to provide a corrosion inhibitor application procedure for protecting embedded objects from corrosion, and which methods are relatively inexpensive and easily effectuated.

It is a further object of the present invention to provide galvanic coatings which enable a relatively high degree of current flow through the system.

### SUMMARY OF THE INVENTION

The galvanic coatings of the present invention have been improved over the types previously described by incorporating additives that improve the conductivity between the sacrificial particles of Zinc and magnesium and the means of connecting to the embedded metallic structure. We have found that when conductive polymers, carbon fibers and graphite are included in the corrosion inhibitor coating composition, a conducting bridge between the sacrificial metal particles and the embedded metallic structure is developed.

We have also found that when conductive media are incorporated in a metal mix of aluminum and magnesium, an effective galvanic coating is formed.

When the coating composition of the present invention is connected to the embedded metallic structure by means of wire or wire screen, there is an improvement in current flow as compared to previously described coatings that do not include such conductive polymers, carbon fibers or graphite.

The need for the present compositions became evident through scaled-up trials. In particular, a trial installation of the coating containing Mg, Zn and humectants was roll-coated on an exterior balcony in a relatively humid environment. The initial (not connected) potential from the coating was −800 m Volts. When connected to the rebar the initial potential was −326 m Volts. The potential fell to −86 mV in two days. After two months the potential was still only −86 mV even in a relatively damp climate. This lack of voltage potential prompted extensive experimentation and the improvement described in this continuation-in-part application.

We have found that the addition of conductive media to coatings containing sacrificial metals such as zinc and magnesium substantially enhances the transmission of the current produced when the sacrificial metal corrodes while attached to the embedded metallic structure.

The addition of conductive media enhances the current flow substantially and enables the preparation of suitable galvanic coatings that do not include magnesium, a metal that must be handled with certain precautions. The galvanic coating prepared with zinc and conductive media functions effectively in most environmental conditions.

In a particular embodiment of the present invention a coating composed of 47% Zn, 17% Mg and 10% carbon fibers by volume was compared to the same combination without the carbon fibers. When the current available was measured, the addition of the carbon fibers increased the conductivity. When measured at 54% humidity (dry) the non-fiber coating was non-conductive (over 40 million ohms/cm) while the carbon fiber included coating averaged 12.5 million ohms/cm in seven readings.

In a 95% RH atmosphere (damp) the Zn—Mg mix averaged 7 million ohms/cm with a range of 4 to 10 million ohms/cm. Including 10% carbon fiber and a conductive polymer, an average of 700,000 ohms/cm was obtained, which is about a ten-fold improvement.

### DETAILED DESCRIPTION OF THE PREFERRED EMBODIMENTS

The objects and advantages enumerated above together with other objects, features, and advances represented by the present invention will now be presented in terms of detailed embodiments. Other embodiments and aspects of the invention are recognized as being within the grasp of those having ordinary skill in the art.

The present invention is directed to coatings for use in the protection of corrosion-susceptible materials embedded within a substrate. Such coatings are particularly adapted for protecting metal reinforcement structures in concrete. The coating is preferably applied to an exterior surface of the substrate utilizing conventional processes.

Various embodiments include liquid applied processes within an organic coating filled with blended metallic particles and/or moisture attracting compounds to provide the protective current to embedded metal, such as reinforcing steel, or rebar, in concrete. Testing has revealed that a protective current can be found to flow to the interior steel reinforcement of concrete test blocks. By transferring the corrosion process from the steel reinforcements to the exterior coating of the present invention, the corrosion of the embedded steel may be significantly inhibited or prevented altogether. Such an exterior coating may be easily maintained or replaced as required to allow a continued protection of the embedded reinforcing steel.

The following examples provide various particular embodiments of the coatings of the present invention. It is contemplated that such formulations represent exemplary compositions only and that many other formulations incorporating the components of the present invention may be derived with successful results, and are within the scope of the present invention.

### EXAMPLE 1

A coating was prepared by blending 100-200 mesh zinc with 100-200 mesh magnesium into a moisture cure urethane polymer E-28 from Bayer. EFKA 8660, a conductive polymer from EFKA additives, and humectants (triethylene glycol) were added to produce a coating suitable for galvanic control.

| | |
|---|---|
| E-28 | 40 grams |
| Zn | 500 grams |
| Mg | 50 grams |
| EFKA 8660 | 2 grams |
| Triethylene glycol | 3 grams |
| Silica | 2.3 grams |
| CaSO₄ | 1.8 grams |

An average of seven resistance values taken were 20 million ohms dry and 2 million ohms damp. The EFKA 8660 addition increased the conductivity of the coating nearly four fold over the control. When the coating was applied to concrete, the connected potential was more than −500 mV.

### EXAMPLE 2

A coating prepared in the same way as Example 1 that included carbon fibers showed improved conductivity.

| | |
|---|---|
| E-28 | 40 grams |
| Zn | 530 grams |
| Mg | 50 grams |
| EFKA | 2 grams |
| Carbon Fibers | 23 grams |
| Humectants | 7 grams |

An average of seven readings showed an average of resistance 700,000 ohms a ten-fold decrease over a Zn and Mg mix.

### EXAMPLE 3

A coating prepared with the addition of graphite showed additional improvement.

| | |
|---|---|
| E-28 | 40 grams |
| Zn | 500 grams |
| Mg | 50 grams |
| EFKA 8660 | 2 grams |
| Carbon Fibers | 20 grams |
| Graphite | 10 grams |
| Humectants | 7 grams |

Such a composition showed an average resistance of 90,000 ohms/cm at 95% RH. When this coating was applied to concrete and connected to the rebar, it maintained a potential of −560 m Volts.

### EXAMPLE 4

A coating prepared with zinc metal particles, conductive fibers, E-28 and humectants functioned well in most environments. When applied to concrete and connected to the resin, the coating maintained a potential of −480 mV.

| | |
|---|---|
| E-28 | 40 grams |
| Zinc | 530 grams |
| Carbon Fibers | 20 grams |
| Humectants | 7 grams |

### EXAMPLE 5

A coating prepared with aluminum and magnesium metal alloy particles with E-28, conductive polymer, conductive fibers, graphite and humectants functioned well in most environments. When applied to concrete and connected to the rebar it maintained a potential of −600 mV.

| | |
|---|---|
| E-28 | 40 grams |
| Aluminum | 100 grams |
| Magnesium | 100 grams |
| EFKA 8660 | 3 grams |
| Carbon Fibers | 20 grams |
| Graphite | 10 grams |
| Humectants | 10 grams |

The following Table 1 provides performance results of the above-described example compositions in comparison to a control composition incorporating only zinc, magnesium and humectants.

TABLE 1

| | Dry | Damp | Open | Closed | |
|---|---|---|---|---|---|
| | Resistance | Resistance | Circuit | Circuit | Voltage |
| Sample | @ 54% RH | @ 95% RH | Potential | Potential | Drop¹ |
| Control: Zn, | >40,000,000 Ohms/Cm | 7,000,000 Ohms/Cm | −660 mV | −494 mV | 166 mV |
| Mg plus | | | | | |
| Humectants | | | | | |
| Example 1: | 20,000,000 Ohms/Cm | 2,000,000 Ohms/Cm | −640 mV | −534 mV | 106 mV |
| Control plus | | | | | |
| EFKA | | | | | |
| conductive | | | | | |
| media | | | | | |
| Example 2: | 2,400,000 Ohms/Cm | 700,000 Ohms/Cm | −622 mV | −537 mV | 85 mV |
| #1 plus | | | | | |
| carbon fiber | | | | | |
| Example 3: | 3,000,000 Ohms/Cm | 90,000 Ohms/Cm | −675 mV | −606 mV | 69 mV |
| #2 plus | | | | | |
| graphite | | | | | |
| Example 4: | 5,800,000 Ohms/Cm | 2,100,000 Ohms/Cm | −595 mV | −510 mV | 85 mV |
| Zn only with | | | | | |
| carbon fiber | | | | | |
| & humectants | | | | | |
| Example 5: | NA | NA | −712 mV | −633 mV | 79 mV |
| Al/Mg, EFKA, | | | | | |
| carbon fiber | | | | | |
| & graphite | | | | | |

*
¹Voltage Drop is a measure of the capacity of the battery/coating to maintain current flow

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different devices and that various modifications can be accomplished without departing from the scope of the invention itself.

What is claimed is:

1. A method for inhibiting corrosion of a metallic member in concrete, said method comprising:
(a) surrounding said metallic member with concrete; and
(b) applying a liquid coating to an exterior surface of said concrete, said liquid coating including:
(i) metallic particles selected from the group consisting of magnesium, zinc, and aluminum; and
(ii) one or more additives selected from the group consisting of carbon fibers, graphite, and combinations thereof.

2. A method as in claim 1 wherein said liquid coating further includes one or more humectants.

3. A method as in claim 1 wherein said carbon fibers are present in said liquid coating at a concentration of between about 2% and about 10% by weight.

4. A method as in claim 1 wherein said graphite is present in said liquid coating at a concentration of between about 1% and about 6% by weight.

5. A method as in claim 1 wherein said liquid coating is applied to said exterior surface of said concrete through brush, spray, or roll methods.

6. A method for inhibiting corrosion of metal structures embedded in a substrate, said method comprising:
(a) applying a liquid coating to an exterior surface of said substrate, said liquid coating including:
(i) metallic particles selected from the group consisting of magnesium, zinc, and aluminum;
(ii) one or more additives selected from the group consisting of conductive polymers, carbon fibers, and combinations thereof; and
(iii) a suitable coating vehicle.

7. A method as in claim 6 wherein said liquid coating further includes one or more humectants.

8. A method as in claim 6 wherein said carbon fibers are present in said liquid coating at a concentration of between about 2% to about 10% by weight.

9. A method as in claim 6 wherein said graphite is present in said liquid coating at a concentration of between about 1% and about 6% by weight.

10. A method as in claim 6 wherein said liquid coating is applied to said exterior surface of said substrate through brush, spray, or roll methods.
